(19) United States
(12) Patent Application Publication
(10) Pub. No.: US 2009/0251669 A1
(43) Pub. Date: Oct. 8, 2009

(54) SIMULATED FIRE APPARATUS

(76) Inventor: PATRICK VIRGILIUS POWER, Kilmacthomas (IE)

Correspondence Address: HOLLAND & KNIGHT LLP, 10 ST. JAMES AVENUE, BOSTON, MA, 02116-3889, US

(21) Appl. No.: 12/061,923

(22) Filed: Apr. 3, 2008

(51) Int. Cl. F21S 10/04; G03B 21/14

(52) U.S. Cl. 353/38

(57) ABSTRACT

Apparatus for simulating a solid fuel flame includes a frame within which is mounted a screen. An enclosure is provided below the screen having a transparent glass refractor member forming a top wall of the enclosure. The refractor member comprises a number of juxtaposed shaped refractor bodies arranged in an edge to edge array on a carrier plate. A cylindrical container is rotatably mounted within the enclosure. A motor rotates the container on a support. The container is partially filled with a red or brown coloured liquid. Lamps within the enclosure are operable to shine light through the coloured liquid in the container and through the refractor member onto the screen. Movement of the coloured liquid, which may be enhanced by internal projections in the container, causes flickering of the light projected onto the screen to give a flame effect simulating a solid fuel fire.

### BACKGROUND OF THE INVENTION

1. Field of the Invention

The present invention relates to an apparatus for simulating a solid fuel fire, and in particular to an apparatus for simulating a solid fuel fire that may be part of or embodied in a heating appliance such as an electric fire, gas fire or fan heater.

2. Description of the Related Art

Many different constructions of simulated fires are known. Various examples are disclosed in Patent Specification Nos. GB 2230335, GB 1457540, GB 407596, GB 315515, WO 03/063664, FR 28 46 562 and EP 1 703 211.

It is an object of the present invention to provide an improved apparatus for simulating a solid fuel fire that mimics a real fire as closely as possible.

### SUMMARY OF THE INVENTION

According to the invention there is provided a simulated fire apparatus, including:
a screen;
a liquid container having a sidewall, at least portion of the sidewall being translucent;
said container being partially filled with a translucent liquid;
a light source arranged to direct light through the container onto the screen;
a container support means for rotatably supporting the container;
means for rotating the container on the container support means;
a refractor member mounted across a light path between the light source and the screen;
said refractor member comprising a number of juxtaposed shaped translucent refractor bodies.

In one embodiment of the invention the refractor member is mounted between the liquid container and the screen.

In another embodiment the refractor bodies have the same shape.

In another embodiment the refractor bodies have a number of different shapes.

In another embodiment the refractor bodies are provided in a number of different sizes.

In another embodiment each refractor bodies has a smooth outer surface.

In another embodiment each refractor body has a curved outer surface.

In another embodiment the refractor bodies are arranged in an array edge to edge.

In another embodiment the bodies are joined together.

In another embodiment the refractor bodies are mounted on a translucent carrier. Preferably the carrier is transparent.

In another embodiment each refractor body is transparent.

In another embodiment each refractor body is formed from glass or a plastics material.

In another embodiment each refractor body comprises a clear glass or plastics material.

In another embodiment the screen is mounted at an angle, inclined forwardly from the vertical between a bottom and a top of the screen, and at least a top of the screen is of arcuate shape.

In another embodiment the screen has a front surface upon which light from the light source is directed, said front surface having a matt finish.

In another embodiment the light source comprises a number of spaced-apart lamps, the lamps being low voltage lamps connected to a transformer which has means for connection to a mains power supply.

In another embodiment each lamp has an associated parabolic reflector, an axis of the reflector being off-set from the vertical and angled inwardly towards the screen.

In another embodiment the axis is off-set by between 4° and 10° and preferably by about 5°-7°.

In another embodiment the refractor member is coloured.

In a further embodiment the container has a number of spaced-apart indentations in a sidewall of the container.

Preferably said indentations are randomly dispersed around the sidewall of the container.

In a preferred embodiment said indentations include a number of shallow indentations at translucent portions of the sidewall, said shallow indentations formed by cut-out grooves in the side wall of the container.

In another embodiment said indentations include deep indentations which project into an interior of the container.

Conveniently said deep indentations are formed by deformations in the sidewall of the container.

In another embodiment the container is cylindrical.

In another embodiment the container is formed from glass.

The sidewall of the container must be at least partially translucent to allow through passage of light and may be partially or fully transparent.

In a further embodiment the screen comprises a reflective plate mounted behind the container and extending upwardly above the container.

In a preferred embodiment the reflective plate has an upright lower portion located directly behind the container and an upper portion angled forwardly of the lower portion, said upper portion being located above the container.

In another embodiment the light source comprises one or more light emitting diodes (LED's).

In another embodiment the liquid in the container is vinegar.

In another aspect the invention provides an electric fire including the simulated fire apparatus as described herein.

Conveniently the electric fire further includes an electric fan heater.

In another embodiment a plurality of inwardly directed projections are provided on an interior of the container wall.

Ideally, the container is partially filled with a coloured liquid. Preferably, the liquid is coloured brown or red.

In one embodiment of the invention, the projections are randomly arranged around the interior of the container. The projections may be of any suitable construction such as blades or the like, or may, for example, be provided by different pieces of a silicone material. Ideally, they are randomly arranged and are of different sizes. They perform two functions, namely, to obscure the light passing through the cylinder and to cause irregular movement of the liquid.

In another embodiment of the invention, additional translucent coloured portions are provided in the container wall. These, for example, can be red, blue, green, yellow and other colours, to simulate various different coloured flames. They may be provided by translucent patches affixed to or painted on the exterior of the container wall.

In another embodiment the container is slightly less than half full with liquid.

In a further embodiment the container is cylindrical and mounted so that its cylindrical wall is substantially horizontal.

In another aspect the invention provides an electric fire incorporating the simulated fire apparatus.

In another embodiment the electric fire includes an electric fan heater.

### BRIEF DESCRIPTION OF THE DRAWINGS

The invention will be more clearly understood from the following description of some embodiments thereof, given by way of example only, with reference to the accompanying drawings, in which:

FIG. 1 is a front view of a fire embodying the apparatus of the invention, with portion removed,

FIG. 2 is a typical sectional view along the line II-II of FIG. 1,

FIG. 3 is a detail perspective view of a refractor member forming portion of the apparatus,

FIG. 4 is an elevational view of the refractor member of FIG. 3,

FIG. 5 is an end elevational view of the refractor member of FIG. 3,

FIG. 6 is a plan view of the refractor member of FIG. 3,

FIG. 7 is an exploded perspective view of another electric heater including flame effect apparatus of the invention,

FIG. 8 is a detail perspective view of portion of the apparatus of FIG. 7, and

FIG. 9 is a detail side sectional elevational view of portion of another apparatus of the invention.

### DESCRIPTION OF THE PREFERRED EMBODIMENTS

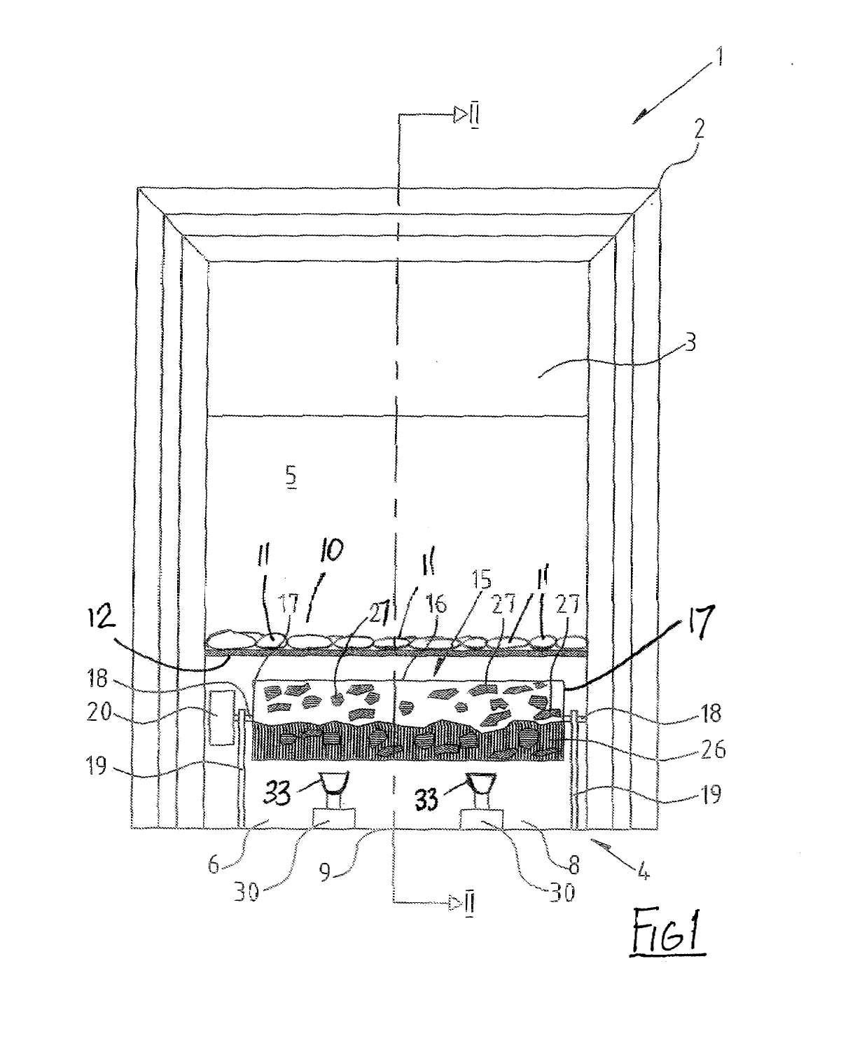

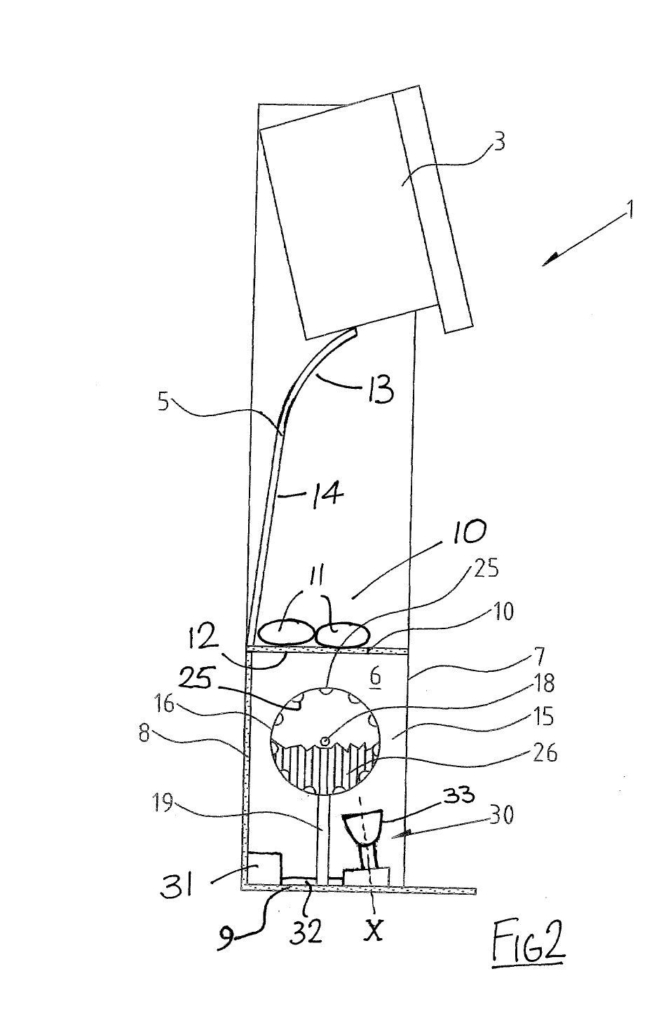

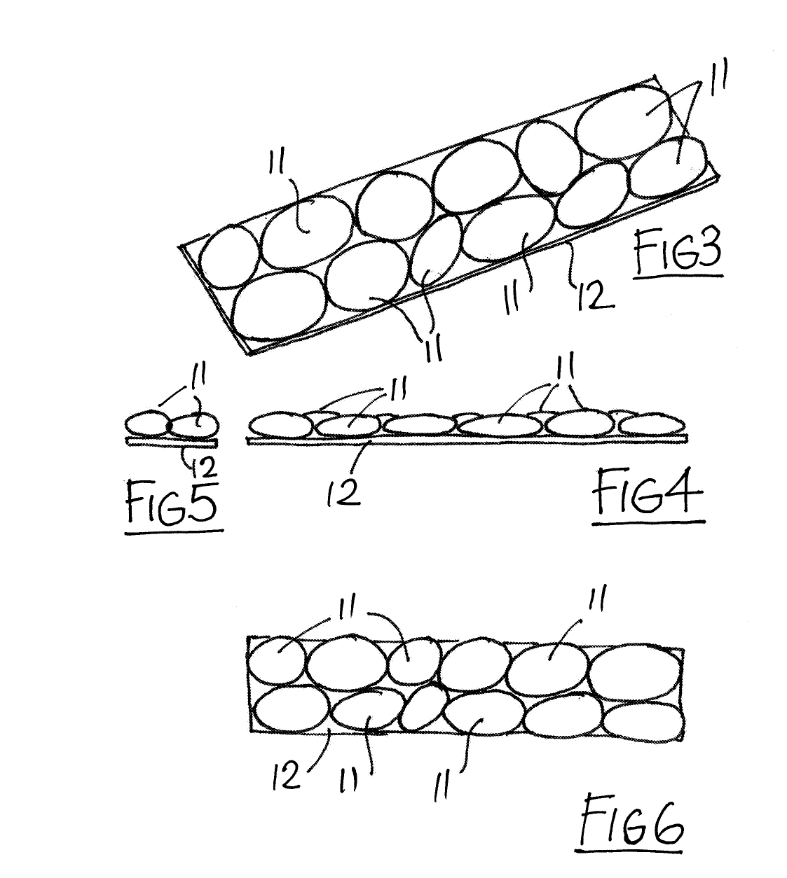

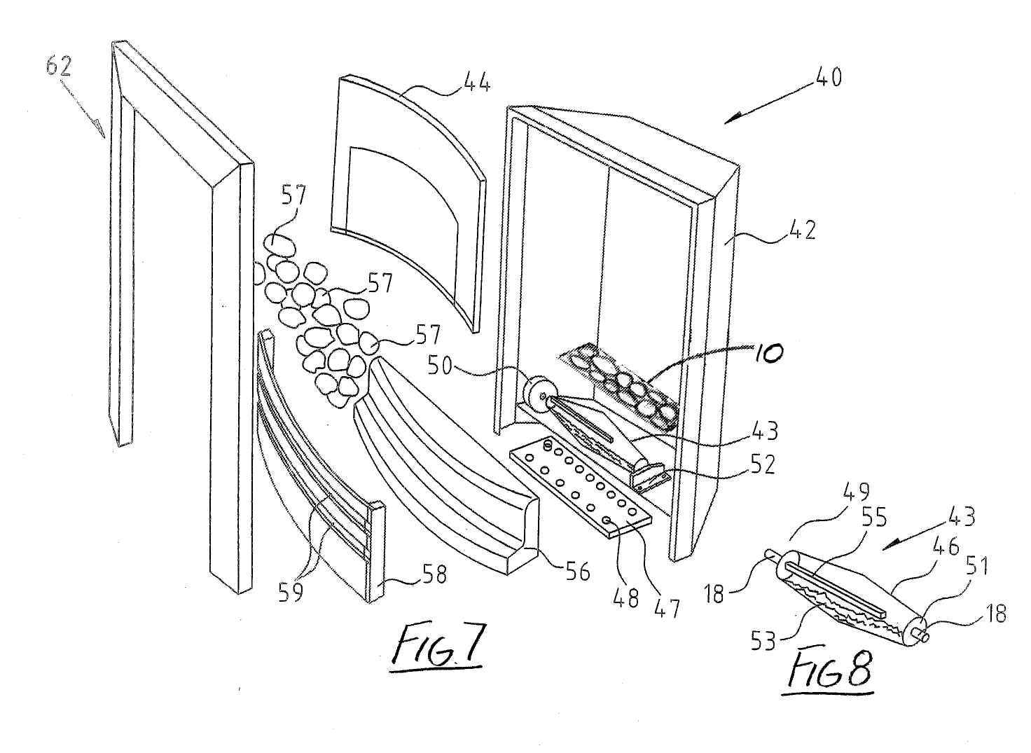

Referring to the drawings, and initially to FIGS. 1 to 6 thereof, there is illustrated an electric fire incorporating a simulated fire apparatus according to the invention, indicated generally by the reference numeral 1, for simulating a solid fuel flame mounted within a fireplace 2 having a fire, in this case, an electric fan heater 3, mounted therein. There is further provided a frame 4 within which is mounted a screen 5. Mounted below the screen 5 is an enclosure 6 having a front wall 7, rear wall 8 and base 9. It further includes a top wall formed by a refractor member 10 of clear transparent glass material. The refractor member 10 comprises a number of juxtaposed shaped refractor bodies 11 arranged in an edge to edge array on a transparent carrier plate 12.

Each refractor body 11 has a pebble-like solid clear body of glass or plastics material. The refractor bodies 11 have random shapes and sizes and each body 11 has a smooth curved outer surface. The refractor bodies 11 are touching and may be joined together where they touch and are fixed on the carrier plate 12.

Mounted within the enclosure 6 is a cylindrical container, indicated generally by the reference numeral 15, having a cylindrical wall 16 mounted between two end plates 17 in turn mounted on stub axles 18 which are rotatably mounted on supports 19. One of the stub axles 18 is driven by a motor 20. The cylindrical wall 16 is of a translucent, preferably transparent, material and mounts a plurality of inwardly directed projections 25 and is approximately half-filled with a coloured liquid, identified by the reference numeral 26. The coloured liquid, in this embodiment, is a reddish-brown colour and may conveniently be provided by vinegar. The projections 25 are for agitation of the liquid 26 as the cylinder 15 rotates. Any other means for agitating the liquid 26 may be provided.

The projections 25 are provided in this embodiment by lumps or blobs of silicone stuck to the inside of the container 15. Patches 27 of a translucent material, in this case, blue and green respectively, are affixed to the exterior of the cylindrical wall 16.

Mounted beneath the container 15 is a pair of spaced-apart lamps 30 providing a light source. These lamps 30 are 12 v lamps connected to a transformer 31 by cable 32. Said transformer 31 has means, such as a conventional cable and electric plug for connection to a mains power supply.

Alternatively, the transformer could be directly wired to the mains power supply via a switch when the fire is installed. Each lamp 30 is mounted within an associated parabolic reflector 33. An axis X of the reflector 33 is off-set from the vertical and angled inwardly, typically by 5°-7° towards the screen 5.

The screen 5 is mounted at an angle, being inclined forwardly from the vertical between a bottom and a top of the screen 5. At least a top portion 13 of the screen 5 is of arcuate shape curving outwardly and upwardly. The screen 5 has a front surface 14 upon which a light from the lamps 30 is directed, said front surface 14 having a matt finish.

In operation, the container 15 is rotated and the liquid 26 will move around the container 15 as it rotates and will be thrown into the interior of the container 15 and upwards and outwards generally in a confused manner by the projections 25 to agitate the surface of the liquid 26. Thus, the light that will be delivered onto the screen 5 from the lamps 30 will flicker. Light radiated from the lamps 30 passes through the liquid 26 in the container 15, then through the refractor member 10 and onto the screen 5. Agitation of a surface of the liquid 26 and the shaped refractor bodies 11 enhance the natural random flame simulation projected onto the screen 5.

It is envisaged that various means may be provided to vary the speed of rotation of the container 15 to further mimic a natural fire burning.

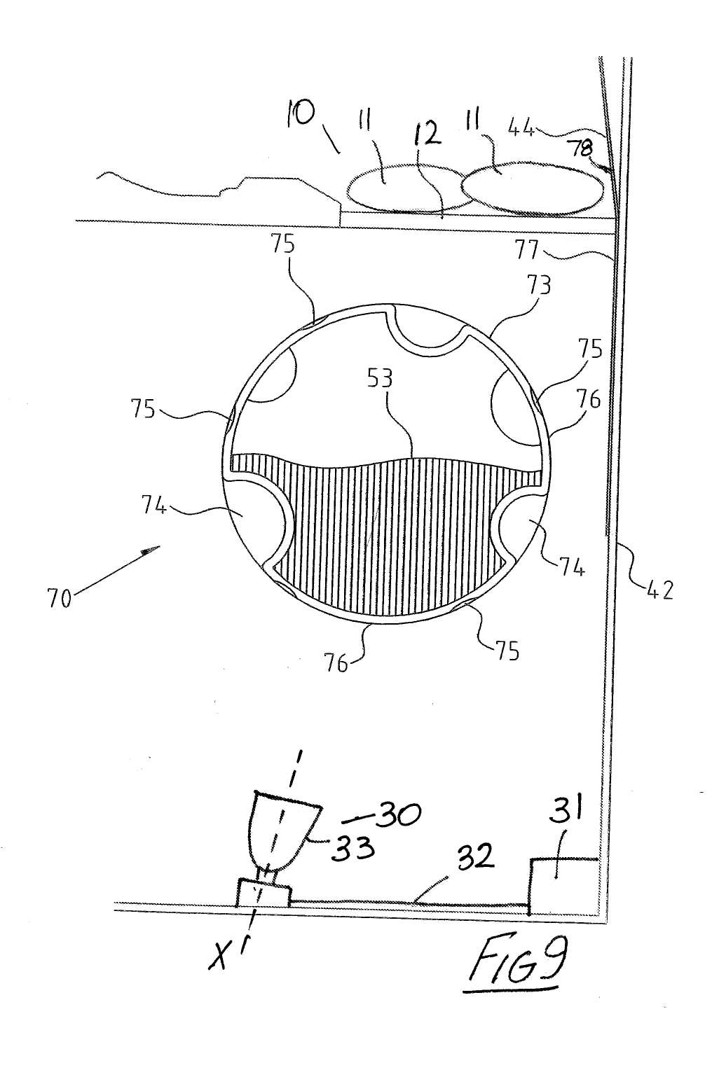

Referring now to FIGS. 7 and 8 there is shown another flame effect fire apparatus according to the invention indicated generally by the reference numeral 40. Parts similar to those described previously are assigned the same reference numerals. The apparatus 40 includes a frame formed by a metal housing 42 within is mounted a rotatable transparent container 43 partially filled with liquid. The container 43 is located beneath a screen reflector 44 mounted within the housing 42 at a rear portion of the housing 42 above the refractor member 10. The refractor member 10 is located between the container 43 and the screen reflector 44. A light panel 47 having a plurality of spaced-apart light emitting diodes 48 is mounted beneath the transparent container 43 for directing light through the container 43 and refractor panel 45 onto the screen reflector 44. The lamp 30 arrangement described previously with reference to FIGS. 1 to 6 could alternatively be used.

The transparent container 43 has a generally cylindrical sidewall 46 although as can be seen particularly in FIG. 8 it tapers inwardly somewhat between a central portion of the container 43 and each end of the container 43. An inner end 49 of the container 43 is connected to a drive motor 50 and an outer end 51 of the container 43 is rotatably supported on an associated mounting bracket 52. The container 43 is partially filled with a brown or red liquid 53 such as vinegar. An internal fin 55 agitates the liquid 53 when the container 43 is rotated by the electric motor 50.

A front panel 56 of transparent resin material is fitted in front of the container 43 and light panel 47 at a front of the housing 42. It will be noted that the front panel 56 is stepped to allow stacking of artificial coals 57 in between the front panel 56 and an associated grille 58 which mounts in front of the panel 56. A number of slots 59 in the grille 58 facilitate viewing of the artificial coals 57. The artificial coal pieces 57 can be made from coloured glass or translucent resin.

A decorative frame 62 is mounted at a front of the housing 42 extending about the sides and top of the housing 42.

An electrical heating fan (not shown) is mounted at a top of the housing 42 as previously described.

In use, the light emitting diodes 48 are illuminated to direct light through the liquid 53 in the container 43 and through the refractor member 10 onto the screen reflector 44. Movement of the liquid 53 within the container 43 provides a flickering flame effect on the screen 44. Some of the light emitting diodes 48 may be coloured red or blue to enhance the flame effect.

Referring now to FIG. 9 there is shown an alternative arrangement for the flame simulating apparatus indicated generally by the reference numeral 70. Parts similar to those described previously are assigned the same reference numerals. In this case a transparent cylindrical container 73 for the coloured liquid 53 is provided which has a number of randomly spaced-apart deep indentations 74 and shallow lens indentations or grooves 75 in a sidewall 76 of the container 73. The deep indentations 74 agitate the liquid 53 as the cylinder 73 rotates and the shallow lens indentations 75 enhance the random flickering effect as light passes through the side wall of the cylinder 73.

The screen reflector 44 has an upright lower portion 77 located directly behind the container 73 and an upper portion 78 angled forwardly of the lower portion 77 above the container 73 and refractor panel 45.

While the refractor members 10 described herein show refractor bodies 11 on a carrier plate 12 in some cases the carrier plate 12 may be dispensed with, the refractor bodies 11 forming a rigid interconnected array. It is also envisaged that loose refractor bodies 11 could be arranged on top of the carrier plate 12, although this is not preferred.

The apparatus of the invention provides a flame effect apparatus which simulates a natural fire. The apparatus may be provided on its own or may incorporate a heating apparatus such as an electric fan heater.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described, but may be varied in both construction and detail within the scope of the appended claims.

1. A simulated fire apparatus, including:
a screen;
a liquid container having a sidewall, at least portion of the sidewall being translucent;
said container being partially filled with a translucent liquid;
a light source arranged to direct light through the container onto the screen;
a container support means for rotatably supporting the container;
means for rotating the container on the container support means;
a refractor member mounted across a light path between the light source and the screen;
said refractor member comprising a number of juxtaposed shaped translucent refractor bodies.

2. The simulated fire apparatus as claimed in claim 1 wherein the refractor member is mounted between the liquid container and the screen.

3. The simulated fire apparatus as claimed in claim 1 wherein the refractor bodies have the same shape.

4. The simulated fire apparatus as claimed in claim 1 wherein the refractor bodies have a number of different shapes.

5. The simulated fire apparatus as claimed in claim 1 wherein the refractor bodies are provided in a number of different sizes.

6. The simulated fire apparatus as claimed in claim 1 wherein each refractor body has a smooth outer surface.

7. The simulated fire apparatus as claimed in claim 1 wherein each refractor body has a curved outer surface.

8. The simulated fire apparatus as claimed in claim 1 wherein the refractor bodies are arranged in an array edge to edge.

9. The simulated fire apparatus as claimed in claim 8 wherein the bodies are joined together.

10. The simulated fire apparatus as claimed in claim 1 wherein the refractor bodies are mounted on a translucent carrier.

11. The simulated fire apparatus as claimed in claim 1 wherein each refractor body is transparent.

12. The simulated fire apparatus as claimed in claim 1 wherein each refractor body is formed from glass or a plastics material.

13. The simulated fire apparatus as claimed in claim 12 wherein each refractor body comprises a clear glass or plastics material.

14. The simulated fire apparatus as claimed in claim 1 wherein the screen is mounted at an angle, inclined forwardly from the vertical between a bottom and a top of the screen, and at least a top of the screen is of arcuate shape.

15. The simulated fire apparatus as claimed in claim 1 wherein the screen has a front surface upon which light from the light source is directed, said front surface having a matt finish.

16. The simulated fire apparatus as claimed in claim 1 wherein the light source comprises a number of spaced-apart lamps, the lamps being low voltage lamps connected to a transformer which has means for connection to a mains power supply.

17. The simulated fire apparatus as claimed in claim 16 wherein each lamp has an associated parabolic reflector, an axis of the reflector being off-set from the vertical and angled inwardly towards the screen.

18. The simulated fire apparatus as claimed in claim 17 wherein the axis is off-set by between 4° and 10°.

19. An electric fire including the simulated fire apparatus as claimed in claim 1.

20. The electric fire as claimed in claim 19 which further includes an electric fan heater.
